(19) United States
(12) Patent Application Publication
(10) Pub. No.: US 2005/0179659 A1
(43) Pub. Date: Aug. 18, 2005

(54) Mouse device

(75) Inventors: Chun-Hsiung Yin, Tainan (TW); Hsun-Li Huang, Hsinchu City (TW); Chih-Wei Wu, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ Corporation

(21) Appl. No.: 11/060,115

(22) Filed: Feb. 17, 2005

(30) Foreign Application Priority Data
Feb. 18, 2004 (TW) 93103996

(51) Int. Cl. G09G 5/08

(52) U.S. Cl. 345/163

(57) ABSTRACT

A mouse device includes a mouse body and a scrolling wheel. The mouse body has a front curved surface, a rear curved surface and a bottom. The bevel and a rear edge of the front curved surface are respectively connected to the bottom and the rear curved surface. The included angle of the front curved surface and the bottom is between 45 and 70 degrees. The scrolling wheel is disposed on the bevel. When operating the mouse device, the user uses an index finger and a portion connecting the index finger and the palm to form an arch atop of the front curved surface and the rear curved surface, thus the mouse body is largely under the index finger. The user can tilt the mouse body for the first scrolling wheel to contact with a working surface and scroll a monitor's screen frame.

This application claims the benefit of Taiwan application Serial No. 93103996, filed Feb. 18, 2004, the subject matter of which is incorporated herein by reference.

### BACKGROUND OF THE INVENTION

1. Field of the Invention

The invention relates in general to a mouse device, and more particularly to a mouse device allowing the user's index finger and the portion connecting the index finger and the palm to form an arch atop to operate the mouse device.

2. Description of the Related Art

Mouse device is one of computer's pointing devices for controlling the cursor's movement on the screen. Considering the popularity and convenience, the mouse device has virtually become one of computer's standard accessories.

However, the design of an ordinary mouse device fails to consider the fact the user's hand size may differ from one to another. While too large a mouse device is a burden to a user with small hands, too small a mouse is awkward for a user with big hands to operate. To develop a mouse device suitable for users to handle regardless of their hand sizes has thus come to the fore.

### SUMMARY OF THE INVENTION

It is therefore an object of the invention to provide a light and compact mouse device suitable for various hand sizes to operate by using a new way of holding the mouse device different from a conventional one.

The invention achieves the above-identified object by providing a mouse device including a mouse body and a scrolling wheel. The mouse body has a front curved surface, a rear curved surface, a bottom, a first side and a second side. A front edge of the front curved surface has a bevel. The bevel and a rear edge of the front curved surface are respectively connected to the bottom and the rear curved surface. The included angle of the front curved surface and the bottom is between 45 and 70 degrees. The first side is opposite to the second side. The two sides of the front curved surface and the rear curved surface are connected to the first side and the second side. The scrolling wheel is disposed on the bevel. When operating the mouse device, a user uses an index finger of a palm of the user and a portion connecting the index finger and the palm to form an arch atop of the front curved surface and rear curved surface, so that the mouse body is largely under the index finger. The user can tilt the mouse body for the first scrolling wheel to come into contact with a working surface and scroll a screen frame of a monitor electrically connected to the mouse device.

According to another object of the invention, a mouse device including a mouse body and a scrolling wheel is provided. The mouse body has a front curved surface, a rear curved surface, a bottom, a first side and a second side. A front edge and a rear edge of the front curved surface are respectively connected to the bottom and the rear curved surface. The included angle of the front curved surface and the bottom is between 45 and 70 degrees. The first side is opposite to the second side. Two sides of the front curved surface and the rear curved surface are connected to the first side and the second side. The scrolling wheel is disposed on either the first side or the second side. When operating the mouse device, a user uses an index finger of a palm of the user and a portion connecting the index finger and the palm to form an arch atop of the front curved surface and rear curved surface, so that the mouse body is largely under the index finger.

According to other object of the invention, a mouse device including a mouse body, a first button, a second button and a scrolling wheel is provided. The mouse body has a front curved surface, a rear curved surface, a bottom, a first fan-shaped side and a second fan-shaped side. A front edge of the front curved surface has a bevel. The bevel and a rear edge of the front curved surface are respectively connected to the bottom and the rear curved surface. The included angle of the front curved surface and the bottom is between 45 and 70 degrees. The first fan-shaped side is opposite to the second fan-shaped side. The two side edges of the front curved surface are respectively connected to the first fan-shaped side and the second fan-shaped side. The first fan-shaped side and the second fan-shaped side respectively have a first arc edge and a second arc edge. The two side edges of the rear curved surface are respectively connected to the first arc edge and the second arc edge. The first button is disposed on the front curved surface. The second button is disposed on either the first fan-shaped side or the second fan-shaped side. The scrolling wheel is disposed on the bevel. when a user operates the mouse device, the user uses an index finger of a palm of the user and a portion connecting the index finger and the palm to form an arch atop of the front curved surface and the rear curved surface, so that the mouse body is largely under the index finger. The user can tilt the mouse body for the first scrolling wheel to come into contact with a working surface and scroll a screen frame of a monitor electrically connected to the mouse device

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. FIG. 1A is a three-dimensional diagram of the mouse device according to preferred embodiment one of the invention;

FIG. 1B is a front view of the mouse device according to preferred embodiment one of the invention;

FIG. 1C is a right side view of the mouse device according to preferred embodiment one of the invention;

FIG. 1D is a top view of the mouse device according to preferred embodiment one of the invention;

FIG. 1E is an upward view of the mouse device according to preferred embodiment one of the invention;

FIG. 2 is a three-dimensional diagram showing an operating mode of the mouse device according to preferred embodiment one of the invention;

FIG. 3 is a three-dimensional diagram of the mouse device according to preferred embodiment two of the invention;

FIG. 4A is a three-dimensional diagram of the mouse device according to preferred embodiment three of the invention; and

FIG. 4B is a front view of the mouse device according to preferred embodiment three of the invention.

### DETAILED DESCRIPTION OF THE INVENTION

### Preferred Embodiment One

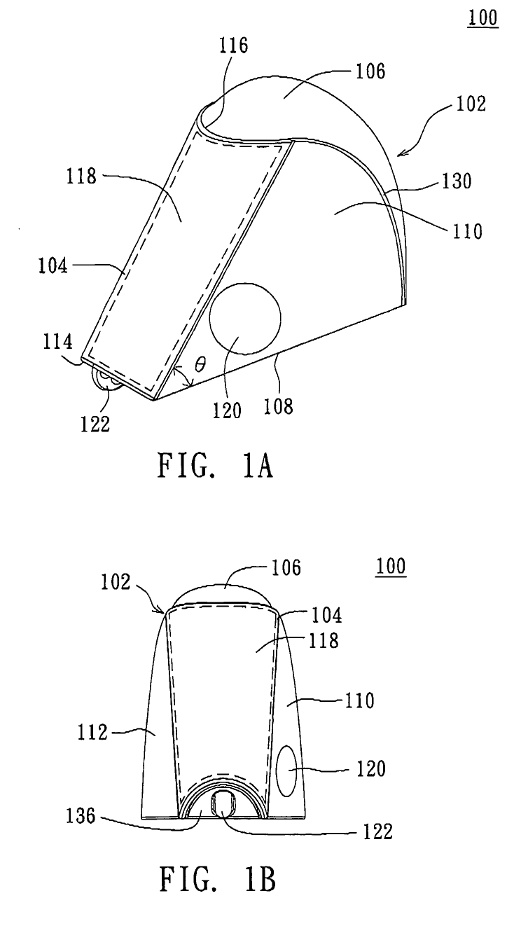

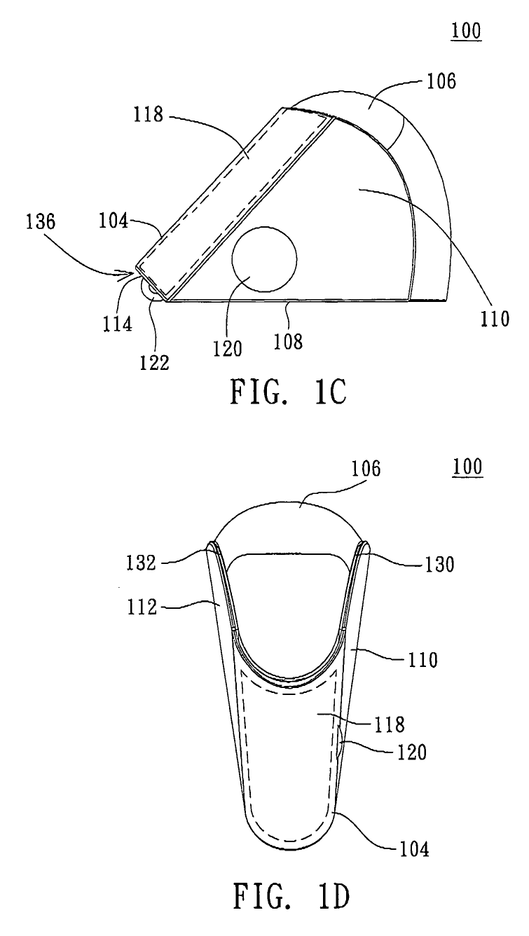

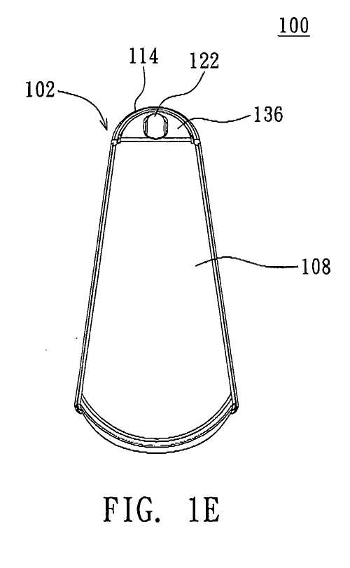

Referring to FIGS. 1A to 1E, a three-dimensional diagram, a front view, a right side view, a top view and an upward view of the mouse device according to preferred embodiment one of the invention are respectively shown. As shown in FIGS. 1A to 1E, mouse device 100 includes a mouse body 102, a first button 118, a second button 120 and a first scrolling wheel 122.

The mouse body 102 has a front curved surface 104, a rear curved surface 106, a bottom 108, and two sides, such as a first fan-shaped side 110 and a opposite second fan-shaped side 112 or two arc-shaped sides. The front edge 114 of the front curved surface and the rear edge 116 of the front curved surface are respectively connected to the bottom 108 and the rear curved surface 106. The two sides of the front curved surface 104 are respectively connected to the first fan-shaped side 110 and the second fan-shaped side 112. The included angle θ of the front curved surface 104 and the bottom 108 is preferably to be between 45 and 70 degrees. The first fan-shaped side 110 and the second fan-shaped side 112 respectively have a first arc edge 130 and a second arc edge 132. The two sides of the rear curved surface 106 are respectively connected to the first arc edge 130 and the second arc edge 132.

However, the front curved surface 104, the structure of first fan-shaped side 110 and that of the second fan-shaped side 112 can be formed as a unit to have better performance in terms of productivity and assembly. Besides, the user will have a better comfort when holding and operating the mouse device 100 if the rear curved surface 106 is either an ergonomic curved surface or capped with a rubber material.

Furthermore, the first button 118 is disposed on the front curved surface 104, while the second button 120 is disposed on the first fan-shaped side 110. The function of the first button 118 and the second button 120 can be designed to fit the user's needs. For example, the first button 118 can have a recognition function, while the second button 120 can have a function menu display function. Besides, the first button 118 can be a plate-type button, which covers the entire front curved surface 104 to have a larger operation area. The second button 120 does not necessarily to be disposed on the first fan-shaped side 110, for example, the second button 120 can also be disposed on the second fan-shaped side 112. Moreover, the second button 120 can be a button-type button.

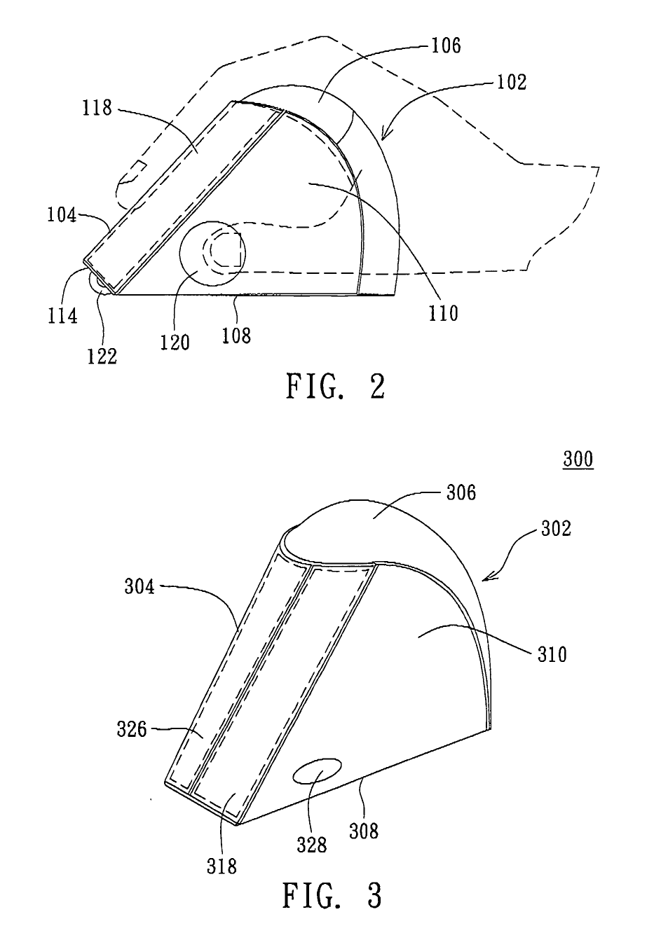

Referring to FIG. 2, a three-dimensional diagram showing an operating mode of the mouse device according to preferred embodiment one of the invention is shown. As shown in FIG. 2, when operating the mouse device 100, the user uses an index finger of a palm of the user and a portion connecting the index finger and the palm to form an arch atop of the front curved surface 104 and rear curved surface 106, so that the mouse body 102 is largely under the user's index finger for controlling the cursor's movement on the screen. Meanwhile, the user's fingers can operate the first button 118 and the second button 120.

Please refer to FIGS. 1A to 1C and FIG. 1E again. The front edge 114 of the front curved surface 104 has a bevel 136. A first scrolling wheel 122 for a user scrolling a screen frame is disposed on the bevel 136. When the user wants to scroll a screen frame, he or she can tilt the mouse body 102 for the first scrolling wheel 122 to come into contact a working surface and scroll a screen frame of a monitor (unshown) electrically connected to the mouse device 100. The disposition of the first scrolling wheel 122 of the mouse device 100 of the present preferred embodiment is different from that of an ordinary mouse device. When the user wants to scroll a screen frame, he or she only the first scrolling wheel 122 by tilting the mouse body 102 slightly, which is indeed very convenient.

In other word, when the user operates the mouse device, the user may bend his or her index finger and place the index finger and the part where the index finger and palm join on the front and rear curved surfaces in order to operate the mouse device with the first button. When the user wants to scroll the screen of the monitor, the user may incline the mouse device forward to enable the scrolling wheel to touch a plane, such as a table surface or the work surface. Then, the user may rotate the mouse device to scroll the screen frame of the monitor by moving the mouse device on the plane forwardly and backwardly.

### Preferred Embodiment Two

Referring to FIG. 3, a three-dimensional diagram of the mouse device according to preferred embodiment two of the invention is shown. As shown in FIG. 3, mouse device 300 includes a mouse body 302, a first button 318, a third button 326 and a second scrolling wheel 328. Preferred embodiment two differs with preferred embodiment one in the number of buttons and the disposition of the scrolling wheel.

In present preferred embodiment, the first button 318 and the third button 326 are both disposed on the front curved surface 304, wherein area ratio between the first button 318 and the third button 326 is about 2:1. The functions of the first button 318 and the third button 326 can be designed to fit the user's needs. For example, the first button 318 can be designed to be a frequently used recognition button, while the third button 326 can be designed to be a function menu display button which is less frequently used.

Furthermore, the second scrolling wheel 328 is disposed on the first fan-shaped side 310. The second scrolling wheel 328 can also be disposed on the second fan-shaped side opposite to the first fan-shaped side 310. When operating the mouse device 300, the user preferably use an index finger to operate the first button 318 and the third button 326 and use a thumb to operate the second scrolling wheel 328.

### Preferred Embodiment Three

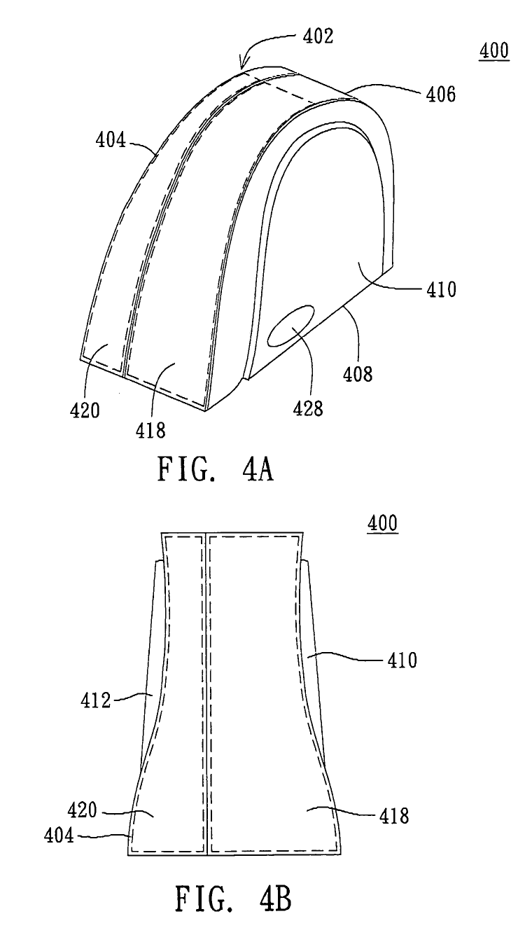

Referring to FIG. 4A and FIG. 4B, a three-dimensional diagram and a front view of the mouse device according to preferred embodiment three of the invention are respectively shown. As shown in FIG. 4A and FIG. 4B, the mouse device 400 includes a mouse body 402, a first button 418, a second button 420 and a scrolling wheel 428. Preferred embodiment three differs with preferred embodiment one in the contour of the lateral side of the mouse body as well as the disposition of the button and the scrolling wheel.

In present preferred embodiment, the mouse body 402 has a front curved surface 404, a rear curved surface 406, a bottom 408 physically the same with that in preferred embodiment one, but has a first arch-shaped side 410 and a opposite second arch-shaped side 412 different from that in preferred embodiment one or two fan-shaped sides. Both sides of the front curved surface 404 and rear curved surface 406 are respectively connected to the first arch-shaped side 410 and the second arch-shaped side 412.

However, the first arch-shaped side 410 and the second arch-shaped side 412 can be capped with a rubber material for instance to give the user better comfort when holding and operating the mouse device 400. Besides, both the first button 418 and the second button 420 of present preferred embodiment are disposed on the front curved surface 404, wherein the area ration between the first button 418 and the second button 420 is about 2:1. Furthermore, the scrolling wheel 428, which is disposed on the first arch-shaped side 410, can also be disposed on and the second arch-shaped side 412 opposite to the first arch-shaped side 410.

The mouse device disclosed in the above preferred embodiments according to the invention incorporates the relationship of the included angle between the front curved surface and the bottom and further designs a new side surface of the mouse body different from a conventional one. When operating the mouse device of the invention, the user holds the mouse device with a thumb and a middle finger and places an index finger on the mouse device, which is indeed very convenient. Following the abovementioned way of holding the mouse device, the mouse device will no longer be subject to the size of user's hand. In other words, the mouse device of the invention fits various hand sizes. Besides, when operating the mouse device of the invention, the user can place his or her wrist on the desk flatly to reduce the burden of the hand, and more importantly, to reduce the morbidity of myotenositis. Besides, in preferred embodiment one of the invention, the disposition of the scrolling wheel of the mouse device is different from that of a conventional mouse device: the scrolling wheel is disposed on the bevel on the front edge of the front curved surface to provide the user with an even convenient way to scroll a screen frame.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A mouse device, comprising:
a mouse body having a front curved surface, a rear curved surface, a bottom, a first side and a second side, wherein a front edge of the front curved surface has a bevel, the bevel and a rear edge of the front curved surface are respectively connected to the bottom and the rear curved surface, the included angle of the front curved surface and the bottom is between 45 and 70 degrees, the first side is opposite to the second side, two side edges of the front curved surface and the rear curved surface are connected to the first side and the second side; and
a scrolling wheel disposed on the bevel;
wherein when a user operates the mouse device, the user uses an index finger of a palm of the user and a portion connecting the index finger and the palm to form an arch atop of the front curved surface and the rear curved surface, so that the mouse body is largely under the index finger;
wherein the user can tilt the mouse body for the first scrolling wheel to come into contact with a working surface and scroll a screen frame of a monitor electrically connected to the mouse device.

2. The mouse device according to claim 1, wherein the first side has a first arc edge, the second side has a second arc edge, and two side edges of the rear curved surface are respectively connected to the first arc edge and the second arc edge.

3. The mouse device according to claim 1, wherein the mouse device further comprises a first button disposed on the front curved surface.

4. The mouse device according to claim 3, wherein the mouse device further comprises a second button disposed on either the first side or the second side.

5. The mouse device according to claim 4, wherein the second button is a button -type button.

6. The mouse device according to claim 1, wherein the front curved surface, the first side and the second side are formed as a unit.

7. The mouse device according to claim 1, wherein the rear curved surface is an ergonomic curved surface.

8. The mouse device according to claim 1, wherein the rear curved surface is capped with a rubber material.

9. The mouse device according to claim 1, wherein the mouse device further comprises a button disposed on either the first side or the second side.

10. The mouse device according to claim 9, wherein the first side and the second side are two fan-shaped sides or two arch-shaped sides.

11. A mouse device comprising:
a mouse body having a front curved surface, a rear curved surface, a bottom, a first side and a second side, wherein a front edge and a rear edge of the front curved surface are respectively connected to the bottom and the rear curved surface, the included angle of the front curved surface and the bottom is between 45 and 70 degrees, the first side is opposite to the second side, two sides of the front curved surface and the rear curved surface are connected to the first side and the second side; and
a scrolling wheel disposed on either the first side or the second side, wherein a user can use the scrolling wheel to scroll a screen frame of a monitor electrically connected to the mouse device;
wherein when the user operates the mouse device, the user uses an index finger of a palm of the user and a portion connecting the index finger and the palm to form an arch atop of the front curved surface and the rear curved surface, so that the mouse body is largely under the index finger.

12. The mouse device according to claim 11, wherein the mouse device further comprises a first button disposed on the front curved surface.

13. The mouse device according to claim 12, wherein the mouse device further comprises a second button disposed on the front curved surface, area ratio between the first button and the second button is 2: 1, when the user operates the mouse device, the user can use the index finger to operate the first button and the second button.

14. The mouse device according to claim 11, wherein the rear curved surface is an ergonomic curved surface.

15. The mouse device according to claim 11, wherein the rear curved surface is capped with a rubber material.

16. The mouse device according to claim 11, wherein the first side or the second side is capped with a rubber material.

17. The mouse device according to claim 1 1,.wherein the first side and the second side are two fan-shaped sides or two arch-shaped sides.

18. A mouse device, comprising:
a mouse body having a front curved surface, a rear curved surface, a bottom, a first fan-shaped side and a second fan-shaped side, wherein a front edge of the front curved surface has a bevel, the bevel and a rear edge of the front curved surface are respectively connected to the bottom and the rear curved surface, the included angle of the front curved surface and the bottom is between 45 and 70 degrees, the first fan-shaped side is opposite to the second fan-shaped side, and the two side edges of the front curved surface are respectively connected to the first fan-shaped side and the second fan-shaped side, the first fan-shaped side and the second fan-shaped side respectively have a first arc edge and a second arc edge, and the two side edges of the rear curved surface are respectively connected to the first arc edge and the second arc edge;
a first button disposed on the front curved surface;
a second button disposed on either the first fan-shaped side or the second fan-shaped side; and
a scrolling wheel disposed on the bevel;
wherein when a user operates the mouse device, the user uses an index finger of a palm of the user and a portion connecting the index finger and the palm to form an arch atop of the front curved surface and the rear curved surface, so that the mouse body is largely under the index finger;
wherein the user can tilt the mouse body for the first scrolling wheel to come into contact with a working surface and scroll a screen frame of a monitor electrically connected to the mouse device.

19. The mouse device according to claim 18, wherein the second button is a button-type button.

20. The mouse device according to claim 18, wherein the front curved surface, the first fan-shaped side and the second fan-shaped side are formed as a unit.

21. The mouse device according to claim 18, wherein the rear curved surface is an ergonomic curved surface.

22. The mouse device according to claim 18, wherein the rear curved surface is capped with a rubber material.
